(19) United States
(12) Patent Application Publication
(10) Pub. No.: US 2026/0330263 A1
(43) Pub. Date: Oct. 22, 2026

(54) GRAPH SEARCH APPARATUS, DIALOGUE APPARATUS, AND GRAPH SEARCH METHOD

(71) Applicant: Hitachi Power Solutions Co., Ltd., Ibaraki (JP)

(72) Inventors: Tatsumasa ISHIKAWA, Tokyo (JP); Yasushi MIYATA, Tokyo (JP)

(21) Appl. No.: 19/647,986

(22) Filed: Apr. 15, 2026

(30) Foreign Application Priority Data
Apr. 22, 2025 (JP) 2025-070564

(51) Int. Cl. G06N 5/04

(52) U.S. Cl. CPC G06N 5/04

(57) ABSTRACT

A graph search apparatus includes: an inference path initialization unit configured to search a knowledge graph for a single node having high relevance to content of an inquiry and set the obtained single node as an initial inference path of an inference path; an inference path update unit configured to select a candidate path considered to be useful as a response to the inquiry from among a plurality of candidate paths and starting from the initial inference path or a tail node of the inference path, and update the inference path with the selected candidate path; and an additional inference path acquisition unit configured to, when a path to be followed next by the node is explicit, search the graph by using a preset path search text, and combine the path obtained by the searching to a tail of the inference path and output the combined path.

### CROSS-REFERENCE TO RELATED APPLICATION

The present application claims priority from Japanese application JP2025-070564, filed on Apr. 22, 2025, the content of which is hereby incorporated by reference into this application.

### BACKGROUND OF THE INVENTION

### 1. Field of the Invention

The present invention relates to a graph search apparatus, a dialogue apparatus, and a graph search method.

### 2. Description of Related Art

In recent years, with the advancement of natural language processing technology, a graph search apparatus that performs knowledge graph searches using generative artificial intelligence (AI) such as a large-scale model, a dialogue apparatus that performs dialogue between a person and a system, and the like have been provided. The knowledge graph is a graph in which a relationship between pieces of information is expressed by nodes and edges.

NPL 1 discloses a dialogue system that searches a knowledge graph based on the content of a user inquiry and returns a response. In the technique disclosed in NPL 1, first, an entity is extracted as an initial topic entity from a given question, and then an iterative process of graph search, context search, and large language models (LLM) inference is executed.

In the graph search process, the technique disclosed in NPL 1 prompts the LLM to detect relationships between all topic entities, select, from a collected relationship set, a relationship having a high possibility of finding an entity including contextual information helpful in answering the question, and score the relationship. At the start of each iteration, the technique disclosed in NPL 1 selectively searches for an entity adjacent to the current topic entity on a knowledge graph, and narrows down an acquisition range using a newly detected entity.

Next, the technique disclosed in NPL 1 ranks and selects entities based on context knowledge acquired from a query and a related document. Thereafter, the LLM answers the question using knowledge such as entity context. If the collected information is insufficient, the LLM further proceeds with the searching.

### Citation List

### Patent Literature

NPL 1: Jiashuo Sun and eight others, “Think-on-Graph: Deep and Responsible Reasoning of Large Language Model on Knowledge Graph”, [online], 2024, Arxiv, search on Feb. 28, 2025, Internet <URL: https://arxiv.org/abs/2307.07697>

### SUMMARY OF THE INVENTION

However, in the invention of NPL 1, there is a typical pattern of following a path from a certain node (entity), and even when the path to be followed next is explicit, the large-scale language model always performs processing of searching for a path. Therefore, a computational cost, a processing time, and the like are excessively generated by the processing.

The invention has been made in view of the above circumstances, and an object of the invention is to provide a graph search apparatus, a dialogue apparatus, and a graph search method capable of reducing a computational cost, a processing time, and the like.

A graph search apparatus according to an aspect of the invention is a graph search apparatus for searching, based on an input inquiry, a knowledge graph including a plurality of nodes indicating information and a plurality of relations indicating a relationship between the plurality of nodes, and outputting, as an inference path, a path including a plurality of the nodes and the relations obtained by the searching. A graph search apparatus according to an aspect of the invention is configured including: an inference path initialization unit configured to search a knowledge graph for a single node having high relevance to content of an inquiry and set the obtained single node as an initial inference path of an inference path; an inference path update unit configured to select a candidate path considered to be useful as a response to the inquiry from among a plurality of candidate paths including a predetermined number of nodes and relations and starting from the initial inference path or a tail node of the inference path, and update the inference path with the selected candidate path; and an additional inference path acquisition unit configured to, when a path to be followed next by the node is explicit, search the graph by using a preset path search text enabling acquisition of the path to be followed next, and combine the path obtained by the searching to a tail of the inference path and output the combined path.

According to at least one aspect of the present invention, a graph search apparatus, a dialogue apparatus, and a graph search method capable of reducing a computational cost, a processing time, and the like are provided.

Problems, configurations, and effects other than those described above will be clarified by the following description of embodiments.

### BRIEF DESCRIPTION OF THE DRAWINGS

FIG. 1 is a block diagram illustrating a schematic configuration example of a graph search apparatus according to a first embodiment of the invention.

FIG. 2 illustrates a hardware configuration of the graph search apparatus according to the first embodiment of the invention.

FIG. 3 is a diagram illustrating a configuration example of a graph according to the first embodiment of the invention.

FIG. 4 is a diagram illustrating a configuration example of an inference path list according to the first embodiment of the invention.

FIG. 5 is a table illustrating a configuration example of an additional path acquisition condition and a path search text list according to the first embodiment of the invention.

FIG. 6 is a table illustrating a configuration example of a path search end condition list according to the first embodiment of the invention.

FIG. 7 is a flowchart illustrating an example of a procedure of computational processing by a computation unit according to the first embodiment of the invention.

FIG. 8 is a flowchart illustrating an example of a procedure of inference path initialization processing according to the first embodiment of the invention.

FIG. 9 is a flowchart illustrating an example of a procedure of inference path update processing according to the first embodiment of the invention.

FIG. 10 is a flowchart illustrating an example of a procedure of additional inference path acquisition processing according to the first embodiment of the invention.

FIG. 11 is a flowchart illustrating an example of a procedure of inference path search end determination processing according to the first embodiment of the invention.

FIG. 12 is a diagram illustrating a configuration example of a graph check screen according to the first embodiment of the invention.

FIG. 13 is a block diagram illustrating a schematic configuration example of a dialogue apparatus according to a second embodiment of the invention.

FIG. 14 is a flowchart illustrating an example of a procedure of computational processing by a computation unit according to the second embodiment of the invention.

### DESCRIPTION OF EMBODIMENTS

Hereinafter, an example of an aspect for implementing the invention (hereinafter referred to as “embodiment”) will be described with reference to the accompanying drawings. The invention is not limited to the embodiment, and various numerical values and the like in the embodiment are examples. In the specification and the drawings, the same components or components having substantially the same functions are denoted by the same reference signs, and a repeated description will be omitted.

### First Embodiment

### Configuration of Graph Search Apparatus

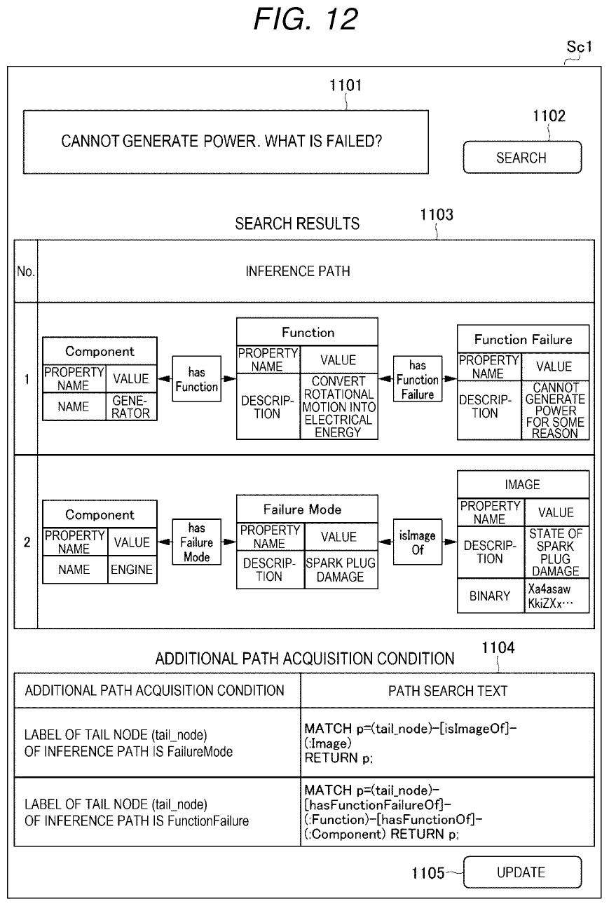

Hereinafter, a first embodiment of the invention will be described. A graph search apparatus according to a first embodiment generates, for a user who wants to check whether appropriate knowledge is stored in content of a graph, information such as a search result when a user inquiry is received. The graph search apparatus displays the information on a graph check screen Sc1 (see FIG. 12). The user who wants to check whether appropriate knowledge is stored in the content of a graph includes, for example, a knowledge graph creator and an administrator.

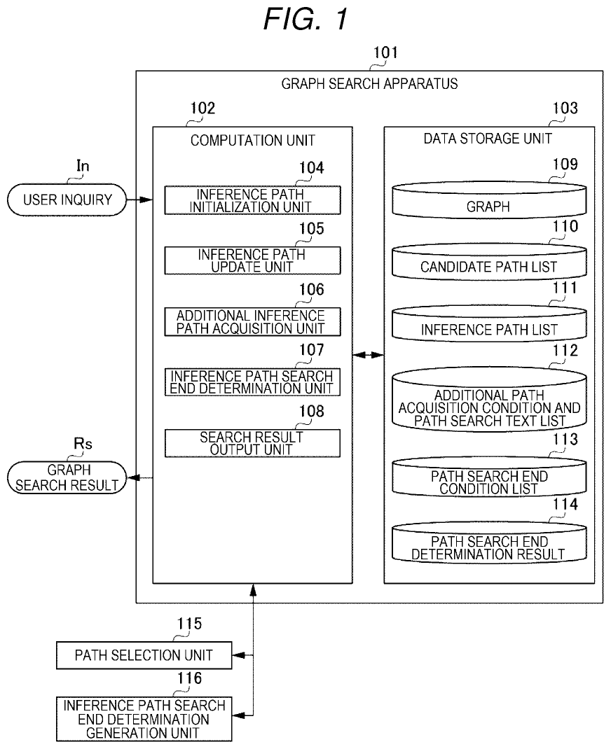

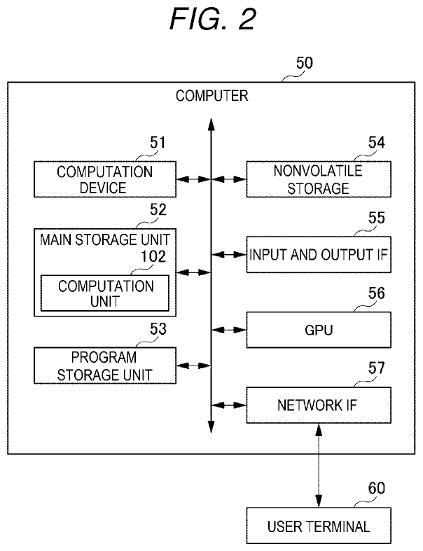

Next, a configuration of a graph search apparatus 101 according to the first embodiment of the invention will be described with reference to FIG. 1. FIG. 1 is a block diagram illustrating a schematic configuration example of the graph search apparatus 101. The graph search apparatus 101 according to the embodiment searches for a knowledge graph 109 (hereinafter, also simply referred to as a “graph”) based on a user inquiry In transmitted from a user terminal 60 (see FIG. 2), and then returns inquiry content and an inference path obtained by the searching to the user terminal as a graph search result Rs.

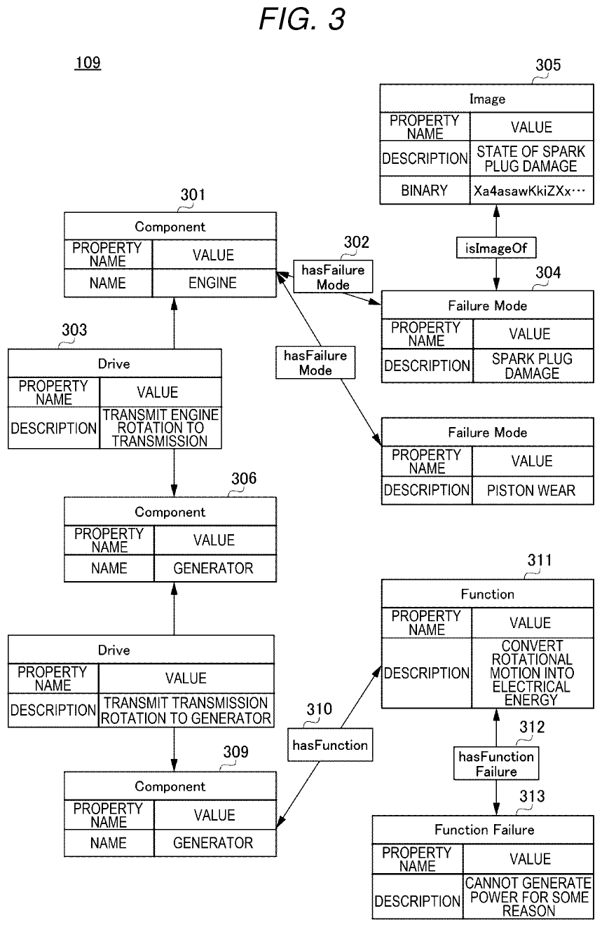

The graph 109 represents knowledge in a graph format, and is represented by nodes indicating individual things, events, and the like, and a relation indicating relationships existing between the nodes. When the graph 109 is, for example, a graph related to a generator, various types of information such as devices constituting the generator, functions of the devices, and types of failure of the devices, an image of each device in a normal state or a failed state, and the like are stored in the nodes. Examples of the relation include a “drive relation” indicating a relationship between a drive source and a drive destination, and a “hasFailureMode relation” connecting a device and a failure mode. The configuration of the graph 109 will be described later with reference to FIG. 3.

The inference path is a path on a graph useful for generating a response to the user inquiry In, and includes a single node on the graph or a node and a relation on the graph. Here, the “useful” path means a path including elements constituting a response to the user inquiry In.

As illustrated in FIG. 1, the graph search apparatus 101 includes a computation unit 102 and a data storage unit 103. A path selection unit 115 and an inference path search end determination generation unit 116 are connected to the graph search apparatus 101. The path selection unit 115 and the inference path search end determination generation unit 116 will be described later.

The computation unit 102 includes an inference path initialization unit 104, an inference path update unit 105, an additional inference path acquisition unit 106, an inference path search end determination unit 107, and a search result output unit 108. When the user inquiry In is received from the user terminal 60 (see FIG. 2), the computation unit 102 performs inference path initialization processing by the inference path initialization unit 104, inference path update processing by the inference path update unit 105, additional inference path acquisition processing by the additional inference path acquisition unit 106, and inference path search end determination by the inference path search end determination unit 107 in this order.

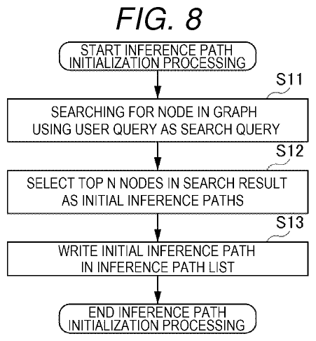

The inference path initialization unit 104 searches the graph 109 for a single node related to the content of the user inquiry In, and writes top N (N being an integer of 1 or more) nodes among nodes obtained by the searching into an inference path list 111 as initial inference paths. The inference path initialization processing by the inference path initialization unit 104 will be described later with reference to FIG. 8.

The inference path update unit 105 receives the inference path list 111 as an input, and acquires, from the graph 109, a path having a length 1 connected from the initial inference path stored in the inference path list 111. A path having a length 1 is a path constituted by one relation and one node. After obtaining the path having a length 1, the inference path update unit 105 stores, as a candidate path in a candidate path list 110, a path obtained by combining the obtained path of length 1 with the initial inference path read from the inference path list 111.

When there are a plurality of paths (candidate paths) having a length of 1 to be connected to the initial inference path, the inference path update unit 105 stores all the acquired candidate paths in the candidate path list 110. Here, the candidate paths acquired by the inference path update unit 105 include all paths branching from the initial inference path. Therefore, the candidate paths also include a path that is useless for the answer to the user inquiry In.

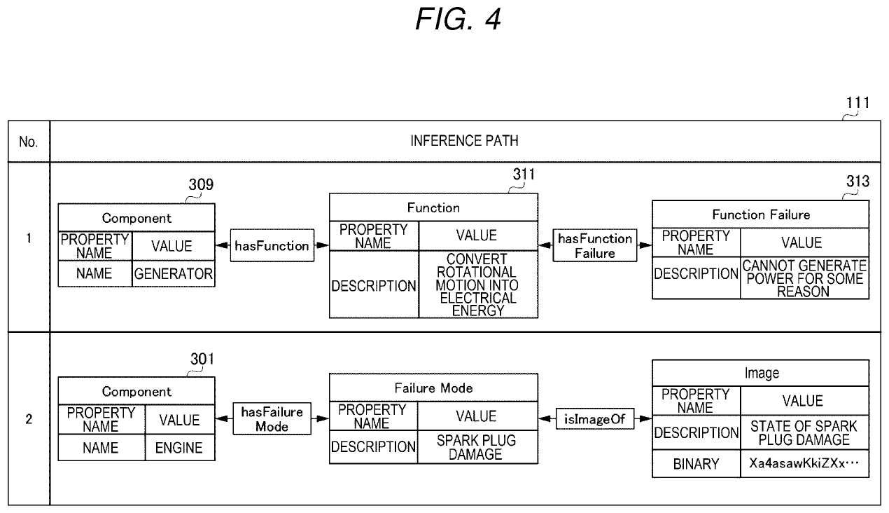

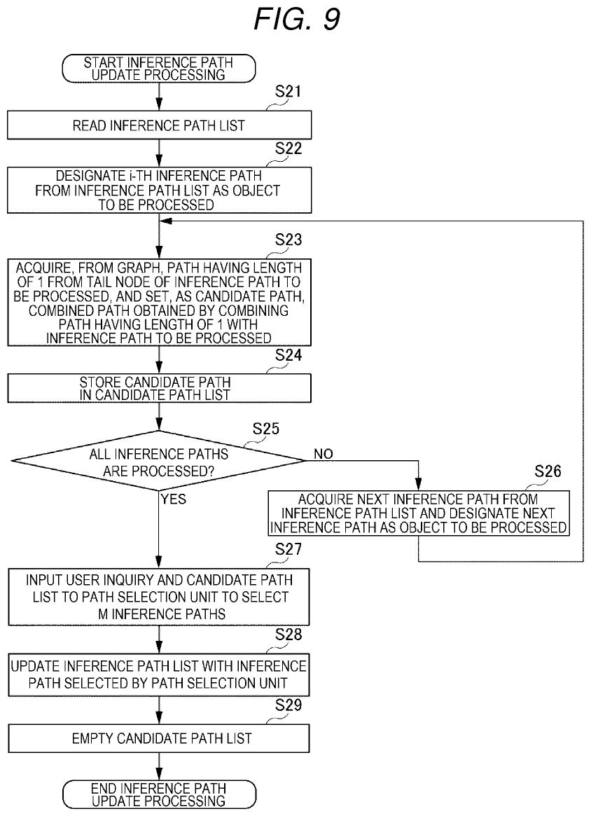

The inference path update unit 105 inputs the candidate path list 110 and the user inquiry In to the path selection unit 115, and obtains a path selection result from the path selection unit 115. The path selection unit 115 includes a generative AI such as a language model or a large-scale language model, and selects and outputs M (M being an integer of 1 or more) useful paths as a response to the user inquiry In from the candidate path list 110. The inference path update unit 105 updates the inference path list 111 using the path indicated by the path selection result obtained by the path selection unit 115. The inference path update processing by the inference path update unit 105 will be described later with reference to FIG. 9, and a configuration of the inference path list 111 will be described later with reference to FIG. 4.

When the inference path update unit 105 inputs a path having a length 1 to the path selection unit 115, with a currently selected node as a starting point, the path selection unit 115 can grasp information on nodes around the starting-point node that can be selected as paths in the future. The path selection unit 115 can appropriately select a node to be selected next (path to be moved) by inputting a path having a length of 1, which is an amount of information that is not too large. When the generative AI constituting the path selection unit 115 has high performance, the inference path update unit 105 may input a path having a length of 2 or more to the path selection unit 115.

Although FIG. 1 illustrates an example in which the path selection unit 115 is configured in a device (not illustrated) different from the graph search apparatus 101, the invention is not limited thereto. The path selection unit 115 may be provided in the graph search apparatus 101.

The additional inference path acquisition unit 106 receives the inference path list 111 as an input, and determines whether the inference path list 111 satisfies an additional path acquisition condition defined in an additional path acquisition condition and path search text list 112. The additional path acquisition condition and path search text list 112 is a list in which the additional path acquisition condition and a path search text are associated with each other. The additional path acquisition condition describes a condition when a path acquired according to a path search text associated with the additional path acquisition condition is added to a tail path of the inference path. The path search text stores a search text for searching for a path to be acquired from the graph 109 when the additional path acquisition condition is satisfied.

For example, when there is a typical pattern of following a path from a certain node, the additional inference path acquisition unit 106 may acquire an explicit path to be followed next and add the acquired path to the end of the inference path. It is assumed that the content of the user inquiry In is requiring diagnosis of a failure, for example. In this case, an order of following the graph 109 is considered to be an order of “identify a failure from a user question”, “identify a failed function”, “find a component performing the function”, “find a failure cause by tracing related components”, and the like. The “typical pattern of “following a path” in such a case is the order of a FunctionFailure node, a Function node, and a Component node. By following the graph 109 in this order, it is possible to find the cause of the problem indicated in the user inquiry In.

In the embodiment, the additional path acquisition condition is set to a condition with which it can be determined whether an input inference path is an explicit path to be followed next. When the additional path acquisition condition is satisfied, the additional inference path acquisition unit 106 does not make an inquiry to the path selection unit 115, and a search for a path using a path search text corresponding to the additional path acquisition condition is performed. In the path search text, a search text capable of acquiring an explicit path to be followed next is defined.

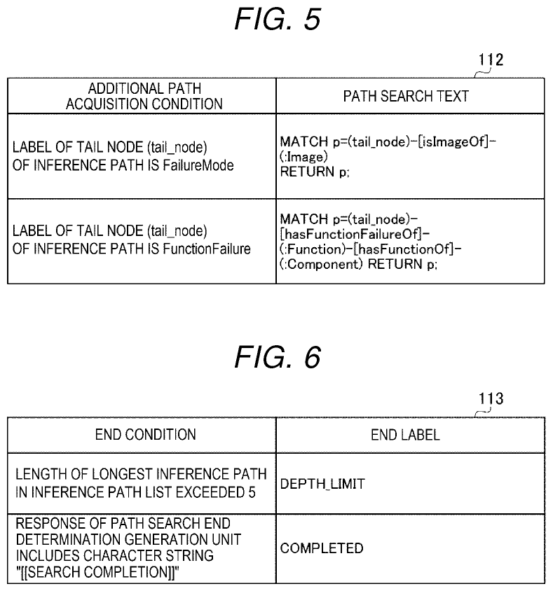

By performing such processing by the additional inference path acquisition unit 106, it is possible to prevent occurrence of a situation in which the path selection unit 115 including a large-scale language model or the like performs path searches every time. Therefore, according to the embodiment, the computational cost, the processing time, and the like of the graph search apparatus 101 can be reduced. The configuration of the additional path acquisition condition and path search text list 112 will be described later with reference to FIG. 5.

If it is determined that the inference path list 111 satisfies the additional path acquisition condition, the additional inference path acquisition unit 106 searches the graph 109 for a path in which the inference path list 111 matches the path search text of the additional path acquisition condition and path search text list 112. Then, the inference path list 111 is updated using the path obtained by the searching based on the path search text.

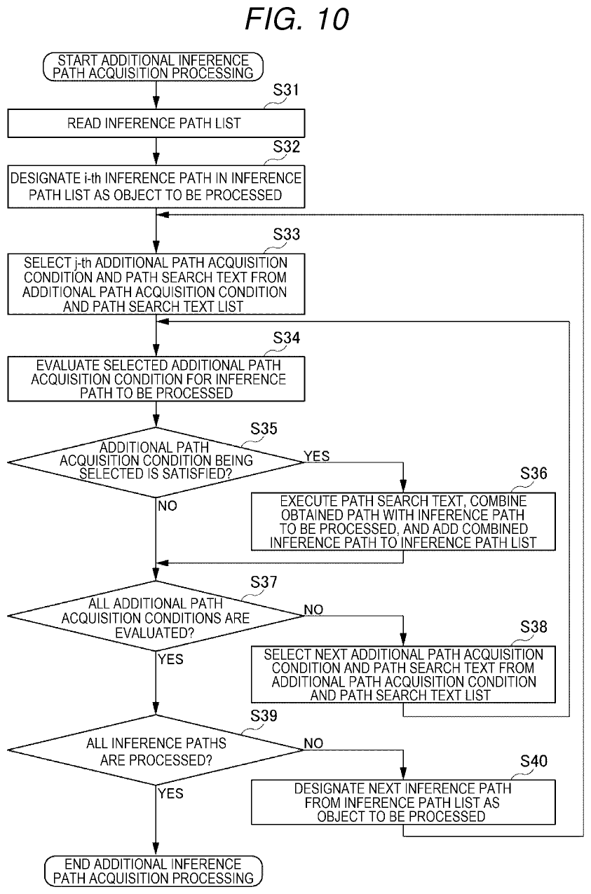

On the other hand, if it is determined that the inference path list 111 does not satisfy the additional path acquisition condition, the additional inference path acquisition unit 106 does not perform the additional inference path acquisition processing. The additional inference path acquisition processing by the additional inference path acquisition unit 106 will be described later with reference to FIG. 10. After the additional inference path acquisition processing by the additional inference path acquisition unit 106 ends, the inference path search end processing by the inference path search end determination unit 107 is performed.

The inference path search end determination unit 107 receives the inference path list 111 as an input, and determines whether the inference path list 111 satisfies a search end condition defined in a path search end condition list 113. If it is determined that the inference path list 111 satisfies the search end condition, the inference path search end determination unit 107 stops updating the inference path list 111. Thereafter, the inference path search end determination unit 107 stores an end label (see FIG. 6) indicating a reason for the update stop in a path search end determination result 114.

Instead of using the path search end condition list 113, the inference path search end determination unit 107 can also obtain a determination result about the necessity of ending update of the inference path list 111 by making an inquiry to the inference path search end determination generation unit 116. The inference path search end determination generation unit 116 includes a language model, a large-scale language model, or the like. The inference path search end determination generation unit 116 receives the user inquiry In and the inference path list 111 as inputs, determines whether to end the searching for the inference path list 111, and returns a determination result to the inference path search end determination unit 107.

Although FIG. 1 illustrates an example in which the inference path search end determination generation unit 116 is configured in a device (not illustrated) different from the graph search apparatus 101, the invention is not limited thereto. The inference path search end determination generation unit 116 may be provided in the graph search apparatus 101.

The search result output unit 108 outputs the inference path read from the inference path list 111 and the additional path acquisition condition and the path search text read from the additional path acquisition condition and path search text list 112 to the user terminal 60 (see FIG. 2) as the graph search result Rs. The search result output unit 108 displays the graph search result Rs on the graph check screen Sc1 (see FIG. 12). The graph check screen Sc1 will be described later with reference to FIG. 12.

The data storage unit 103 stores the graph 109, the candidate path list 110, the inference path list 111, the additional path acquisition condition and path search text list 112, the path search end condition list 113, and the path search end determination result 114. A value of “True” or “False” as the path search end determination result and an end label are stored in the path search end determination result 114. The end label is a label indicating a cause (reason) of the path update end when the path update of the inference path list 111 by the inference path search end determination unit 107 is ended.

### Hardware Structure of Graph Search Apparatus

Next, a hardware structure of the graph search apparatus 101 will be described with reference to FIG. 2. FIG. 2 is a block diagram illustrating a hardware structure example of the graph search apparatus 101. A computer 50 illustrated in FIG. 2 is hardware used as a so-called computer, and constitutes the graph search apparatus 101.

As illustrated in FIG. 2, the computer 50 includes a computation device 51, a main storage unit 52, a program storage unit 53, a nonvolatile storage 54, an input and output interface (IF) 55, a graphics processing unit (GPU) 56, and a network IF 57.

The computation device 51 includes a central computation device, for example. The computation device 51 implements processing of each functional block of the computation unit 102 (see FIG. 1) by loading a program stored in the program storage unit 53 into the main storage unit 52 and executing the program.

The main storage unit 52 includes a random access memory (RAM), for example. In the main storage unit 52, variables, parameters, and the like generated during the computational processing of the computation unit 102 (see FIG. 1) are temporarily written.

The program storage unit 53 includes, for example, a read only memory (ROM). The program is stored in a form of a program code readable by a computer, and the computation device 51 sequentially executes operations according to the program code. That is, the program storage unit 53 is also used as an example of a computer-readable non-transitory recording medium that stores the program to be executed by the computer.

The nonvolatile storage 54 includes, for example, a hard disk or a solid state drive. The nonvolatile storage 54 may include a combination of a plurality of storage devices.

The input and output IF 55 performs communication between the graph search apparatus 101 and an external device. Examples of the external device include a display, a keyboard, a mouse, a flash memory, and a printer.

The GPU 56 includes a video random access memory (VRAM) and performs drawing processing and computational processing in response to a request from the computation device 51. The GPU 56 can also execute a part of processing performed by the computation device 51 and processing performed by the path selection unit 115 and the inference path search end determination generation unit 116.

The network IF 57 is a communication interface for the graph search apparatus 101 to achieve communication with another external device such as the user terminal 60, and includes a network interface card or the like.

### Configuration of Graph

Next, a configuration of the graph 109 will be described with reference to FIG. 3. FIG. 3 is a diagram illustrating a configuration example of the graph 109. FIG. 3 illustrates an example of the graph 109 showing information on functions, failure modes, and the like of a gasoline engine generator.

As illustrated in FIG. 3, the graph 109 includes nodes and relations. The nodes include, for example, a Component node 301, a Failure Mode node 304, and an Image node 305. Each node has two items of a “label” and a “property”. The label is metadata indicating a type of the node. Examples of the label include “Component” indicating a component of a machine, “Failure Mode” indicating a typical failure mode that may occur in each component, and “Image” indicating an image obtained by imaging a state of a component or a failure.

The property is information indicating an attribute of the node, such as a name of the node or a description of the node. The property has items of a “property name” and a “value”. The item “property name” stores a name of the property, and the item “value” stores a value corresponding to information indicated in the property name.

For example, the Component node 301 is a node in which information on “engine”, which is a component of a machine, is stored, and the Failure Mode node 304 is a node in which information on “spark plug damage”, which is a typical failure mode that may occur in the component, is stored. The Image node 305 is a node that stores an image obtained by imaging a state of the spark plug damage. FIG. 3 illustrates an example in which the image obtained by imaging the state of the spark plug damage is composed of binary data of “Xa4asawKkiZXx . . . ”. A plurality of types of node properties may be set, including “description” and “binary” in the Image node 305.

The relation is information indicating a relationship between nodes, and examples thereof include a “hasFailureMode relation” and a “Drive relation”. The “hasFailureMode relation” is a relation indicating having a failure mode. For example, a hasFailureMode relation 302 connects the Component node 301 and the Failure Mode node 304. That is, the hasFailureMode relation 302 is a relation indicating that the Component node 301 whose name is “engine” has a failure mode of “spark plug damage” indicated by the Failure Mode node 304.

The Drive relation is a relation indicating that the components indicated by the connected Component nodes have a drive-driven relationship. For example, a Drive relation 303 is a relation storing a description reading “transmit engine rotation to transmission”, and connects the Component node 301 and a Component node 306. The Component node 306 is a node indicating information on a component whose name is “transmission”. That is, the Drive relation 303 is a relation indicating that the Component node 301 whose name is “engine” is connected to the Component node 306 indicating the information on the component whose name is “transmission” in a relationship of “transmit engine rotation to transmission”.

Regarding the relations, it is possible to have a plurality of properties in one relation in the same manner as the nodes.

### Configuration of Inference Path List

Next, the configuration of the inference path list 111 will be described with reference to FIG. 4. FIG. 4 is a diagram illustrating a configuration example of the inference path list 111. As illustrated in FIG. 4, the inference path list 111 is a list of paths in each of which a head and a tail are constituted by nodes and nodes are connected by a relation. In the inference path list 111, each inference path is managed in association with an identification number such as “1” or “2”.

The initial inference path, which is a single node selected from the graph 109 by the inference path initialization unit 104 based on the content of the user inquiry In, is stored as a head path of the inference path. In the example illustrated in FIG. 4, the head path of the inference path of number “1” is a Component node 309, and the head path of the inference path of number “2” is the Component node 301. Inference paths acquired by the inference path update unit 105 or inference paths acquired by the additional inference path acquisition unit 106 are sequentially connected to the initial inference path in a row, thereby forming an inference path as illustrated in FIG. 4. When the inference path search end determination unit 107 determines that the inference path list 111 satisfies the search end condition defined in the path search end condition list 113, the update (addition) of the inference path is ended, and the content of the inference path is finalized.

In FIG. 4, an example of case where the user inquiry In is, for example, “Cannot generate power. What is failed” described in a search box 1101 on the graph check screen Sc1 in FIG. 12 described later is illustrated. In FIG. 4, as the initial inference path in the case where the user inquiry In is “Cannot generate power. What is failed”, number “1” indicates the Component node 309, and number “2” indicates the Component node 301. The Component node 309 is a node storing information that the name is “generator”, and the Component node 301 is a node storing information that the name is “engine”.

For example, in the inference path associated with number “1”, a Function node 311 is connected to the Component node 309, which is the initial inference path, via a hasFunction relation 310. A Function Failure node 313 is connected to the Function node 311 via a hasFunctionFailure relation 312. The hasFunction relation is a relation indicating that a device has a function. The Function Failure node 313 is a node in which a function to “convert rotational motion into electrical energy” is defined.

### Configuration of Additional Path Acquisition Condition and Path Search Text List

Next, the additional path acquisition condition and path search text list 112 will be described with reference to FIG. 5. FIG. 5 is a table illustrating a configuration example of the additional path acquisition condition and path search text list 112.

As illustrated in FIG. 5, the additional path acquisition condition and path search text list 112 includes items of an “additional path acquisition condition” and a “path search text”.

A condition that “label of tail node (tail-node) of inference path is FailureMode” is described as the additional path acquisition condition in a top row of the additional path acquisition condition and path search text list 112 illustrated in FIG. 5. In the path search text, a search text “MATCH p=(tail_node)−[isImageOf]−(:Image) RETURN p;” is described. This path search text is a search text instructing to return a path p that is connected by an isImageOf relation with tail_node as a head node and an Image label as a tail node.

For example, a case is assumed where the tail node in the inference path list 111 input to the additional inference path acquisition unit 106 is the Function Failure node 313. In this case, “label of tail node (tail_node) of inference path is FunctionFailure”, which is the additional path acquisition condition in the second row in the additional path acquisition condition and path search text list 112, is satisfied. Therefore, the additional inference path acquisition unit 106 acquires, from the graph 109, nodes that satisfy the search text “MATCH p=(tail_node)−[hasFunctionFailureOf]−(: Function)−[hasFunctionOf]−(:Component)RETURN p;” and updates the second row of the inference path list 111 with the acquired nodes.

### Configuration of Path Search End Condition List

Next, the path search end condition list 113 will be described with reference to FIG. 6. FIG. 6 is a table illustrating a configuration example of the path search end condition list 113.

As illustrated in FIG. 6, the path search end condition list 113 includes items of an “end condition” and an “end label”.

The item “end condition” stores a condition for ending the path update of the inference path list 111. The item “end label” stores information on an end label written in the path search end determination result 114 (see FIG. 1). The end label is a label indicating the cause (reason) when the path update of the inference path list 111 ends.

For example, an end condition that “length of longest inference path in inference path list exceeds 5” and an end label “DEPTH_LIMIT” are associated with each other in a top row in the path search end condition list 113. By checking information on the end label of the path search end determination result 114, for example, when an intended search result is not obtained, the user can take measures such as changing the content of the user inquiry In or adjusting the configuration of the graph 109 based on the information indicated by the end label.

### Computational Processing by Computation Unit

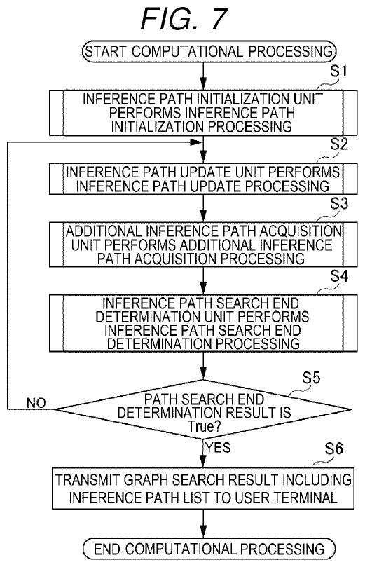

Next, processing by the computation unit 102 (see FIG. 1) of the graph search apparatus 101 will be described with reference to FIG. 7. FIG. 7 is a flowchart illustrating an example of a procedure of the computational processing performed by the computation unit 102.

First, the computation unit 102 performs the inference path initialization processing by the inference path initialization unit 104 (step S1). The inference path initialization processing in step S1 will be described later with reference to FIG. 8. Next, the computation unit 102 performs the inference path update processing by the inference path update unit 105 (step S2). The inference path update processing in step S2 will be described later with reference to FIG. 9.

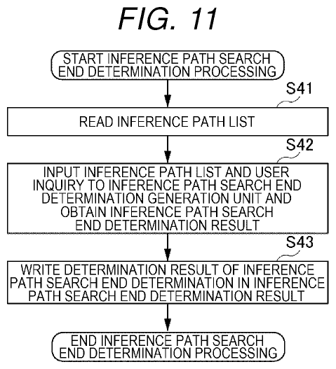

Next, the computation unit 102 performs the additional inference path acquisition processing by the additional inference path acquisition unit 106 (step S3). The additional inference path acquisition processing in step S3 will be described later with reference to FIG. 10. Next, the computation unit 102 performs the inference path search end determination processing by the inference path search end determination unit 107 (step S4). The inference path search end determination processing in step S4 will be described later with reference to FIG. 11.

Next, the computation unit 102 determines whether “True” is stored in the path search end determination result 114 (see FIG. 1) (step S5). If it is determined in step S5 that “False” is stored in the path search end determination result 114 (NO in step S5), the computation unit 102 returns the process to step S2 and performs the inference path update processing. On the other hand, if it is determined that “True” is stored (YES in step S5), the search result output unit 108 of the computation unit 102 transmits the graph search result Rs including the inference path list 111 to the user terminal 60 (step S6). Then, the search result output unit 108 displays the graph search result Rs on the graph check screen Sc1 (see FIG. 12). After the processing of step S6, the computational processing by the computation unit 102 ends.

### Inference Path Initialization Processing

Next, the inference path initialization processing performed by the inference path initialization unit 104 in step S1 in FIG. 7 will be described with reference to FIG. 8. FIG. 8 is a flowchart illustrating an example of a procedure of the inference path initialization processing.

First, the inference path initialization unit 104 searches for a node in the graph 109 by using the user inquiry In as a search query (step S1). For example, when the user inquiry In is “Cannot generate power. What is failed”, the inference path initialization unit 104 searches for the Component node 309, the Component node 301, or the like (see FIG. 3) that is a node related to “power generation”. The Component node 309 is a node storing information that the name is “generator”, and the Component node 301 is a node storing information that the name is “engine”.

Next, the inference path initialization unit 104 selects top N nodes in the search result as initial inference paths (step S12). Next, the inference path initialization unit 104 writes the selected initial inference paths in the inference path list 111 (step S13). After the processing of step S13, the inference path initialization processing ends.

### Inference Path Update Processing

Next, the inference path update processing performed by the inference path update unit 105 in step S2 in FIG. 7 will be described with reference to FIG. 9. FIG. 9 is a flowchart illustrating an example of a procedure of the inference path update processing.

First, the inference path update unit 105 reads the inference path list 111 from the data storage unit 103 (step S21). Next, the inference path update unit 105 acquires an i-th (i being an integer of 1 or more) inference path from the read inference path list 111, and sets the inference path as an object to be processed (step S22). When the inference path update processing by the inference path update unit 105 is performed for the first time, i=“1”.

Next, the inference path update unit 105 acquires, from the graph 109, a path having a length of 1 starting from the inference path to be processed, and combines the acquired path with the path to be processed acquired in step S22 (step S23). Then, the combined path is stored in the candidate path list 110 as a candidate path (step S24).

For example, it is assumed that the inference path set as the object to be processed by the inference path update unit 105 in step S22 is the Function Failure node 313 at the lower right end of the graph 109 illustrated in FIG. 3. In this case, in step S23, the inference path update unit 105 acquires a path including the hasFunctionFailure relation 312 and the Function node 311 as a path having a length of 1 starting from the Function Failure node 313 that is the inference path to be processed. Then, the inference path update unit 105 combines the acquired path with the path to be processed. Then, the inference path update unit 105 stores a path including the Function Failure node 313, the hasFunctionFailure relation 312, and the Function node 311 in the candidate path list 110 as a candidate path.

Next, the inference path update unit 105 determines whether all inference paths are processed (step S25). If it is determined in step S25 that an unprocessed inference path remains (NO in step S25), an inference path next to the inference path acquired in step S22 is acquired, and the path is set as an object to be processed (step S26). That is, in the processing of step S26, processing of substituting “i+1” into “i” is performed. After the processing of step S26, the inference path update unit 105 returns to step S23 to perform the processing.

On the other hand, if it is determined in step S25 that all inference paths are processed (YES in step S25), the inference path update unit 105 inputs the user inquiry In and the candidate path list 110 to the path selection unit 115 (see FIG. 1) to select M inference paths (step S27). As described above, the path selection unit 115 includes generative AI such as a large-scale language model, and outputs a useful path as a response to the user inquiry In.

Next, the inference path update unit 105 updates the inference path list 111 by using the M inference paths output from the path selection unit 115 (step S28). Next, the inference path update unit 105 empties the candidate path list 110 (step S29). After the processing of step S29, the inference path update processing ends.

### Additional Inference Path Acquisition Processing

Next, the additional inference path acquisition processing performed by the additional inference path acquisition unit 106 in step S3 in FIG. 7 will be described with reference to FIG. 10. FIG. 10 is a flowchart illustrating an example of a procedure of the additional inference path acquisition processing.

First, the additional inference path acquisition unit 106 reads the inference path list 111 from the data storage unit 103 (step S31). Next, the additional inference path acquisition unit 106 acquires the i-th inference path from the read inference path list 111, and sets the inference path as an object to be processed (step S32). Next, the additional inference path acquisition unit 106 selects j-th (j being an integer of 1 or more) additional path acquisition condition and path search text from the additional path acquisition condition and path search text list 112 (step S33).

Next, the additional inference path acquisition unit 106 evaluates the selected additional path acquisition condition for the inference path to be processed (step S34). Next, the additional inference path acquisition unit 106 determines whether the inference path to be processed satisfies the additional path acquisition condition being selected (step S35). As described above, the additional path acquisition condition is satisfied when the inference path is an explicit path to be followed next.

If it is determined in step S35 that the inference path to be processed satisfies the selected additional path acquisition condition (YES in step S35), the additional inference path acquisition unit 106 executes a search using a path search text corresponding to the additional path acquisition condition, and combines an obtained path with the inference path to be processed. The additional inference path acquisition unit 106 adds, to the inference path list 111, the path obtained by combining the path searched according to the path search text with the inference path to be processed (step S36).

If the determination in step S35 is NO, or after the processing in step S36, the additional inference path acquisition unit 106 determines whether all the additional path acquisition conditions are evaluated (step S37). If it is determined in step S37 that an unevaluated additional path acquisition condition remains (NO in step S37), the additional inference path acquisition unit 106 selects the next (j+1-th) additional path acquisition condition and path search text from the additional path acquisition condition and path search text list 112 (step S38). After the processing of step S38, the additional inference path acquisition unit 106 returns the process to step S34 to perform the processing.

On the other hand, if it is determined in step S37 that all the additional path acquisition conditions are evaluated (YES in step S37), the additional inference path acquisition unit 106 determines whether all the inference paths are processed (step S39). If it is determined in step S39 that an unprocessed inference path remains (NO in step S39), the additional inference path acquisition unit 106 sets, as the object to be processed, an inference path next to the inference path set as the object to be processed in step S33 (step S40). That is, in the processing of step S40, processing of substituting “i+1” into “i” is performed. After the processing of step S40, the additional inference path acquisition unit 106 returns to step S33 to perform the processing.

On the other hand, if it is determined in step S39 that all inference paths are processed (YES in step S39), the additional inference path acquisition processing ends.

### Inference Path Search End Determination Processing

Next, the inference path search end determination processing performed by the inference path search end determination unit 107 in step S4 in FIG. 7 will be described with reference to FIG. 11. FIG. 11 is a flowchart illustrating an example of a procedure of the inference path search end determination processing.

First, the inference path search end determination unit 107 reads the inference path list 111 from the data storage unit 103 (step S41). Next, the inference path search end determination unit 107 inputs the inference path list 111 and the user inquiry In to the inference path search end determination generation unit 116, and obtains a determination result from the inference path search end determination generation unit 116 (step S42). Note that the inference path search end determination unit 107 may determine whether to end the inference path search by using the path search end condition list 113 without making an inquiry to the inference path search end determination generation unit 116.

Next, the inference path search end determination unit 107 writes the determination result output from the inference path search end determination generation unit 116 (or the determination result based on the path search end condition list 113) in the path search end determination result 114 (step S43). After the processing of step S43, the inference path search end determination processing ends.

### Configuration of Graph Check Screen

Next, a configuration of the graph check screen Sc1 will be described with reference to FIG. 12. FIG. 12 is a diagram illustrating a configuration example of the graph check screen Sc1. The graph check screen Sc1 is displayed on a display unit or the like of the user terminal 60 (see FIG. 2).

As illustrated in FIG. 12, the graph check screen Sc1 includes the search box 1101, a search button 1102, a search result display portion 1103, an additional path acquisition condition display portion 1104, and an update button 1105.

The search box 1101 is an input portion to which content of an inquiry from the user is input. FIG. 12 illustrates an example in which a sentence reading “Cannot generate power. What is failed” is input.

The search button 1102 is a button for transmitting information input to the search box 1101 to the graph search apparatus 101 as the user inquiry In when pressed. The transmission of the user inquiry In is performed under the control of a control unit (not illustrated) of the user terminal 60.

The search result display portion 1103 is an area in which the search result Rs (see FIG. 1) from the graph search apparatus 101 is displayed. The computation unit 102 of the graph search apparatus 101 performs the computational processing illustrated in FIG. 7 using the user inquiry In transmitted from the user terminal 60 as an input, and outputs an inference path as the search result Rs. FIG. 12 illustrates an example in which inference paths managed by numbers “1” and “2” of the inference path list 111 shown in FIG. 4 are displayed in the search result display portion 1103.

By checking the display content in the search result display portion 1103, a user such as a creator or an administrator of the graph 109 can determine whether the graph 109 is appropriately configured. That is, by checking the display content in the search result display portion 1103, the user can check whether the graph 109 or the graph search apparatus 101 can output an appropriate answer to the inquiry input to the search box 1101.

The additional path acquisition condition display portion 1104 is an area in which the additional path acquisition condition and the path search text list of the additional path acquisition condition and path search text list 112 are displayed. Information displayed in the additional path acquisition condition display portion 1104 can be changed by the user.

The update button 1105 is a button for transmitting content corrected by the user in the additional path acquisition condition display portion 1104 to the graph search apparatus 101. The information transmitted to the graph search apparatus 101 is written in the additional path acquisition condition and path search text list 112 by the computation unit 102 of the graph search apparatus 101. That is, the content of the additional path acquisition condition and path search text list 112 is updated with the content corrected by the user.

In the above-described embodiment, when a path to be followed next by a node is explicit, the additional inference path acquisition unit 106 searches a graph by using a preset path search text enabling acquisition of the path to be followed next, combines the path obtained by the searching with a tail of an inference path, and outputs the combined path. Therefore, according to the embodiment, since it is possible to prevent the occurrence of a situation in which the path search by the path selection unit 115 is executed every time even though the path to be followed next is explicit, the computational cost can be reduced.

In the above-described embodiment, although an example in which the graph search apparatus 101 includes the graph 109 is described, the invention is not limited thereto. For example, the graph 109 may be provided in another external device (not illustrated) capable of communicating with the graph search apparatus 101.

In the above-described embodiment, although an example is described in which the path selection unit 115 and the inference path search end determination generation unit 116 are implemented by separate generative AI, the invention is not limited thereto. The path selection unit 115 and the inference path search end determination generation unit 116 may be implemented by the same generative AI.

In addition, in the above-described embodiment, although an example is described in which the user inquiry In including a sentence (character string) is input to the graph search apparatus 101, the invention is not limited thereto. For example, each of the path selection unit 115 and the inference path search end determination generation unit 116 may be implemented by a multimodal language model capable of inputting and outputting images, sounds, and the like. Further, by using a vector search engine based on a multimodal embedding model as a search engine used when the inference path initialization unit 104 searches for an initial inference path, the graph search apparatus 101 can also perform a graph search based on a user inquiry In including an image, a sound, and the like.

In the above-described embodiment, although an example is described in which the inference path initialization unit 104 selects top N nodes in the search result as the initial inference paths, the invention is not limited thereto. For example, a language model (generative AI model) may be provided inside or outside the inference path initialization unit 104, and all nodes searched by the inference path initialization unit 104 may be input to the language model to select necessary nodes. With such a configuration, the inference path initialization unit 104 can extract an important node necessary for a search as an inference path without fail.

In the above-described embodiment, although an example is described in which the path selection unit 115 selects M inference paths, the invention is not limited thereto, and for example, the number of inference paths output by the path selection unit 115 may not be limited. That is, the inference path update unit 105 may update the inference path list 111 using all the inference paths output from the path selection unit 115. With such a configuration, the inference path update unit 105 can extract an important inference path necessary for a search without fail.

### Second Embodiment

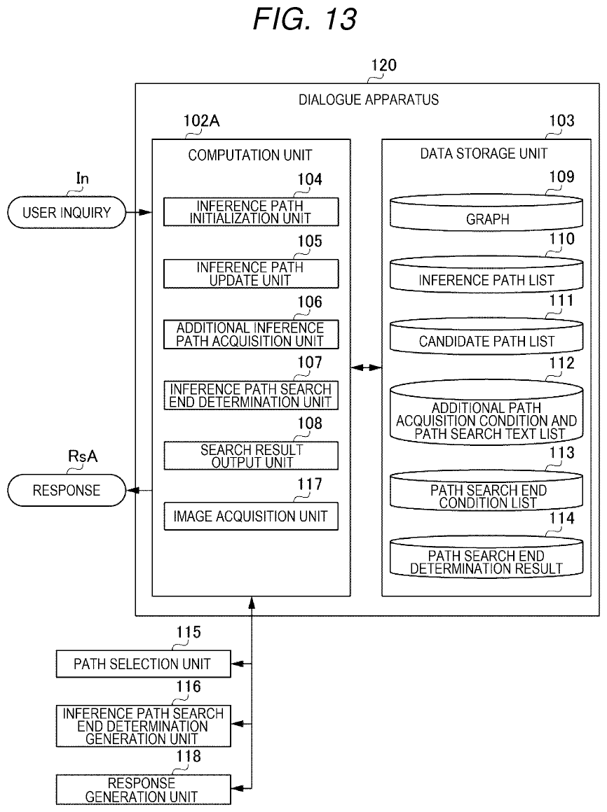

Next, a dialogue apparatus 120 according to a second embodiment of the invention will be described with reference to FIG. 13. FIG. 13 is a block diagram illustrating a schematic configuration example of the dialogue apparatus 120. The dialogue apparatus 120 illustrated in FIG. 13 is configured by adding a response acquisition unit 117 and a response generation unit 118 to the graph search apparatus 101 illustrated in FIG. 1. In the dialogue apparatus 120 illustrated in FIG. 13, a description of the configuration common to the graph search apparatus 101 illustrated in FIG. 1 will be omitted.

The response acquisition unit 117 inputs the inference path list 111 obtained by a graph search and the user inquiry In to the response generation unit 118, and causes the response generation unit 118 to generate a response RsA to the user inquiry In. The response generation unit 118 uses information on the inference path stored in the inference path list 111 to create a sentence constituting the response RsA, and returns the sentence to the response acquisition unit 117. The response generation unit 118 may include, for example, a large-scale language model.

For example, when information on the inference path with the number “2” in the inference path list 111 illustrated in FIG. 4 is used, the response generation unit 118 can create a response RsA such as “The following are possible causes: damage of the spark plug of the engine . . . (omitted). An image showing a state in which the spark plug is damaged is shown below . . . ” or the like. Then, the response acquisition unit 117 returns the response RsA generated by the response generation unit 118 to the user terminal 60 (see FIG. 2).

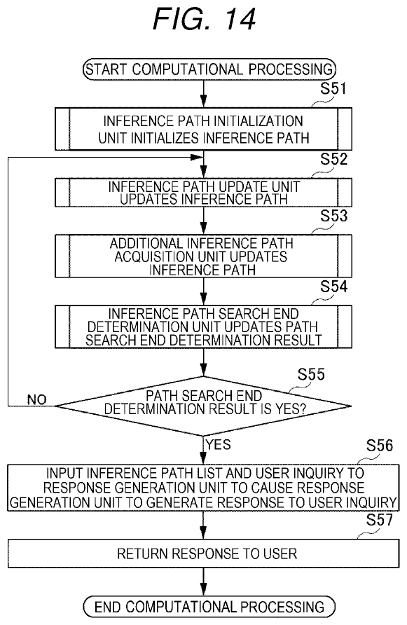

Next, computational processing performed by a computation unit 102A according to the second embodiment will be described with reference to FIG. 14. FIG. 14 is a flowchart illustrating an example of a procedure of the computational processing. Processing of step S51 to step S55 in FIG. 14 is the same as the processing of step S1 to step S5 in FIG. 7, and thus a repeated description will be omitted.

If it is determined in step S55 that the path search end determination result is “True” (YES in step S55), the response acquisition unit 117 inputs the inference path list 111 and the user inquiry In to the response generation unit 118, and causes the response generation unit 118 to generate a response RsA to the user inquiry In (step S56). Next, the response acquisition unit 117 returns the response RsA output from the response generation unit 118 to the user terminal 60 (step S57). After the processing of step S57, the computational processing performed by the computation unit 102A ends.

According to the second embodiment described above, the same effects as those obtained by the first embodiment can be obtained. Further, according to the second embodiment, the user can obtain a quick response from the dialogue apparatus 120. This is because, as in the first embodiment, when there is a typical pattern of following a path from a certain node and the path to be followed next is explicit, an inquiry is not made to the path selection unit 115, and a path matching the path search text is acquired, so that the time required for computational processing is reduced.

In the embodiments and modifications described above, a configuration of a functional block is merely an example. Some functional configurations shown as separate functional blocks may be integrated, or a configuration shown in one functional block diagram may be divided into two or more functions. Further, some of the functions of each functional block may be provided in another functional block.

Further, although a program is stored in the program storage unit 53 in the above-described embodiments and modifications, the program may be stored in the data storage unit 103. In addition, the graph search apparatus 101 may include an input and output interface (not illustrated), and the program may be loaded as necessary from another device to the graph search apparatus 101 or the dialogue apparatus 120 via a medium that can be used by the input and output interface and the graph search apparatus 101 or the dialogue apparatus 120.

Here, the medium refers to, for example, a storage medium detachable from the input and output interface, or a communication medium, that is, a network such as a wired, wireless, or optical network, or a carrier wave or a digital signal propagating through the network. In addition, some or all of the functions implemented by the program may be implemented by a hardware circuit, a field-programmable gate array (FPGA), or the like.

The embodiments and modifications described above may be combined with one another. Although various embodiments and modifications have been described above, the invention is not limited to the content thereof. Other aspects conceivable within the scope of the technical idea of the invention are also included within the scope of the invention.

What is claimed is:

1. A graph search apparatus for searching, based on an input inquiry, a knowledge graph including a plurality of nodes indicating information and a plurality of relations indicating a relationship between the plurality of nodes, and outputting, as an inference path, a path including a plurality of the nodes and the relations obtained by the searching, the graph search apparatus comprising:
an inference path initialization unit configured to search the knowledge graph for a single node having high relevance to content of the inquiry and set the obtained single node as an initial inference path of the inference path;
an inference path update unit configured to select a candidate path considered to be useful as a response to the inquiry from among a plurality of candidate paths including a predetermined number of the nodes and the relations and starting from the initial inference path or a tail node of the inference path, and update the inference path with the selected candidate path; and
an additional inference path acquisition unit configured to, when a path to be followed next by the node is explicit, search the graph by using a preset path search text enabling acquisition of the path to be followed next, and combine the path obtained by the searching to a tail of the inference path and output the combined path.

2. The graph search apparatus according to claim 1, further comprising:
an inference path search end determination unit configured to determine, based on the content of the inquiry and the inference path, whether to end a search for a path to be connected to a tail of the inference path.

3. The graph search apparatus according to claim 2, wherein
the inference path update unit inputs the inference path to a path selection unit including a language model, and causes the path selection unit to select all the candidate paths considered to be useful as a response to the inquiry.

4. The graph search apparatus according to claim 2, wherein
the inference path search end determination unit determines whether to end the searching for the path based on description content of a path search end condition list in which a condition for ending the searching for the path to be connected to the tail of the inference path is described.

5. The graph search apparatus according to claim 3, wherein
the inference path search end determination unit inputs the content of the inquiry and the inference path to an inference path search end determination generation unit including a language model, and causes the inference path search end determination generation unit to determine whether to end the searching for the path.

6. The graph search apparatus according to claim 2, further comprising:
a graph search result output unit configured to transmit, as a graph search result to a terminal device to which the inquiry is input, the inference path for which the inference path search end determination unit determines to end the searching for the path, and display the inference path as a graph check screen on a display unit of the terminal device.

7. The graph search apparatus according to claim 6, wherein
the graph check screen displays, in addition to the inference path, an additional path acquisition condition used for determining whether the path to be followed next is explicit, and the path search text used when the additional path acquisition condition is satisfied.

8. A dialogue apparatus for searching, based on an input inquiry, a knowledge graph including a plurality of nodes indicating information and a plurality of relations indicating a relationship between the plurality of nodes, and outputting a response generated from an inference path including a plurality of the nodes and the relations obtained by the searching, the dialogue apparatus comprising:
an inference path initialization unit configured to search the knowledge graph for a single node having high relevance to content of the inquiry and set the obtained single node as an initial inference path of the inference path;
an inference path update unit configured to select a candidate path considered to be useful as a response to the inquiry from among a plurality of candidate paths including a predetermined number of the nodes and the relations and starting from the initial inference path or a tail node of the inference path, and update the inference path with the selected candidate path;
an additional inference path acquisition unit configured to, when a path to be followed next by the node is explicit, search the graph by using a preset path search text, and combine the path obtained by the searching to a tail of the inference path and output the combined path; and
a response generation unit configured to generate and output the response to the inquiry based on the inquiry and the inference path.

9. The dialogue apparatus according to claim 8, wherein
the response generation unit includes a language model.

10. A graph search method to be used by a graph search apparatus for searching, based on an input inquiry, a knowledge graph including a plurality of nodes indicating information and a plurality of relations indicating a relationship between the plurality of nodes, and outputting, as an inference path, a path including a plurality of the nodes and the relations obtained by the searching, the graph search method comprising:
causing an inference path initialization unit to search the knowledge graph for a single node having high relevance to content of the inquiry and set the obtained single node as an initial inference path of the inference path;
causing an inference path update unit to select a candidate path considered to be useful as a response to the inquiry from among a plurality of candidate paths including a predetermined number of the nodes and the relations and starting from the initial inference path or a tail node of the inference path, and update the inference path with the selected candidate path; and
causing an additional inference path acquisition unit to, when a path to be followed next by the node is explicit, search the graph by using a preset path search text enabling acquisition of the path to be followed next, and combine the path obtained by the searching to a tail of the inference path and output the combined path.
